(19) United States
(12) Patent Application Publication
(10) Pub. No.: US 2005/0178933 A1
(43) Pub. Date: Aug. 18, 2005

(54) Car audio/visual system

(76) Inventor: Ki Bok Yoo, Gyeongsangbuk-do (KR)

Correspondence Address: OSHA LIANG L.L.P., 1221 MCKINNEY STREET, SUITE 2800, HOUSTON, TX, 77010, US

(21) Appl. No.: 10/498,380

(22) PCT Filed: Mar. 22, 2004
(86) PCT No.: PCT/KR04/00622

(30) Foreign Application Priority Data
Feb. 16, 2004 (KR) 1020040010106

(51) Int. Cl. F16M 11/00

(52) U.S. Cl. 248/176.1; 248/917

(57) ABSTRACT

Disclosed is a car A/V system including a display part rotatably provided at a side of the housing part coupled to the inside of a car, and a disk player part provided on a rear surface of the display part for playing various disks. The car A/V system minimizes a thickness of the whole product and enables a visual confirmation of the disk inserted therein when power is not supplied thereto.

### CROSS-REFERENCE TO RELATED APPLICATIONS

This application claims the benefit of Korean Application No. P2004-10106, filed on Feb. 16, 2004, which is hereby incorporated by reference as if fully set forth herein.

### BACKGROUND OF THE INVENTION

1. Field of the Invention

The present invention relates to an AV system, and more particularly, to a car AV system.

2. Discussion of the Related Art

In general, a car A/V (Audio/Visual) system including a tuner, a cassette deck, and a CD player is used for listening to music or radio.

Particularly, in recent years, in accordance with a development of an LCD (Liquid-Crystal Display) technology, the car A/V system is provided with the LCD installed on the car for enabling to watch TV, VCD (Video Compact Disc) or DVD (Digital Video Disc) during transportation. There are various types of the A/V system such as a stand-alone type, a ceiling mount type, and a headrest type.

An example of the ceiling mount type A/V system applied by a same applicant of this patent is described in a korean patent application with an application number of 20-2003-0000610. However, the related art mentioned above has a problem that a total size of the system is increased due to an LCD monitor 12 and a DVD player 13 separately manufactured and provided at a side of a housing part 11 and a center thereof as illustrated in FIG. 1.

Accordingly, in recent years, the ceiling mount type A/V system is provided in a minimized total size as illustrated in FIG. 2. The ceiling mount type A/V system includes a housing part 21 and a DVD player 23 formed as a single body such that the housing part 21 forms an outer appearance of the DVD player 23, and an LCD monitor 22 provided on a bottom surface of the housing part 21. Therefore, the total size on both left and right sides of the ceiling mount type A/V system is reduced compared to the related art.

In this case, an opening 21a for inserting a disk (CD or DVD) is provided on a front surface of the housing part 21 and various parts such as an optical pickup and a turntable as well as various circuit parts included in the DVD player 23 are provided in the housing part 21.

On a front bottom surface of the housing part 21, various switches (not illustrated) are provided for operating the DVD player 23, and on a rear surface of the housing part 21, a terminal for connecting the system with exterior equipments is provided.

In this instance, an undescribed number 1 is a ceiling inside of the car. However, the unified type car A/V system abovementioned has a problem of increasing the thickness of the whole system owing to the DVD player 23 and the LCD monitor 22 lied one upon another.

In addition to the aforementioned problem, there is another problem of damaging a disk by forcibly inserting the disk into the system wherein a disk is placed already. In the unified type car A/V system, the disk is inserted into the system and then rotated, thus it is difficult to confirm whether the disk is in or not unless a power is supplied thereto.

### SUMMARY OF THE INVENTION

Accordingly, the present invention is directed to a car A/V system that substantially obviates one or more problems due to limitations and disadvantages of the related art.

An object of the present invention is to provide a car A/V system with a minimized total thickness of the product.

Another object of the present invention is to provide a car A/V system enabling a visual confirmation of a disk inserted therein when power is not supplied thereto.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a car A/V system includes a housing part coupled to a predetermined location in a car, a display part rotatably provided at a side of the housing part, and a disk player part provided on a rear surface of the display part for playing various disks.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a perspective view illustrating a car A/V system according to the related art.

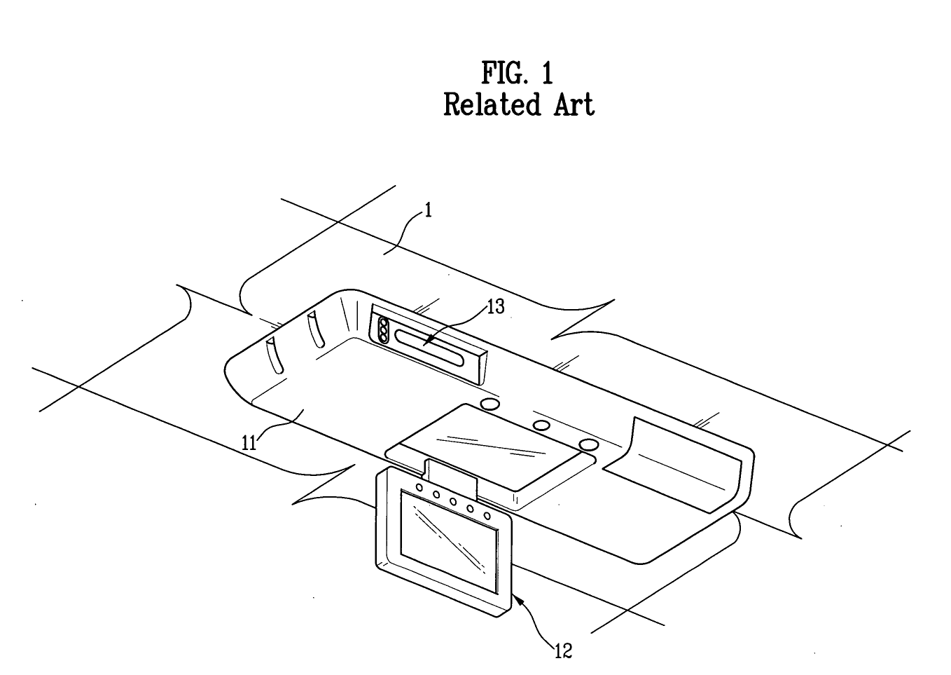

FIG. 2 is a perspective view illustrating another example of a car A/V system according to the related art.

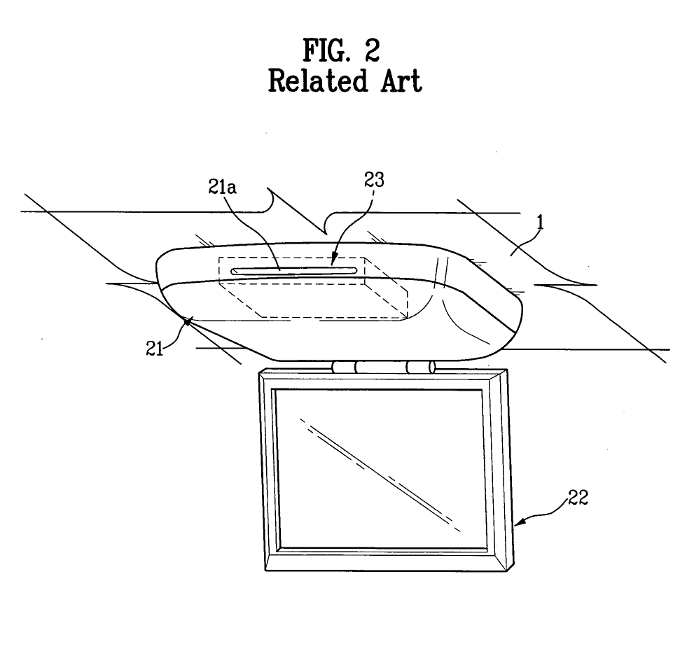

FIG. 3 is a perspective view illustrating an A/V system with a display part being ejected according to the present invention.

FIG. 4 is a perspective view illustrating a car A/V system with a display part being closed according to the present invention.

FIG. 5 is a base plane view illustrating a car A/V system provided on a car ceiling according to the present invention.

FIG. 6 is a perspective view illustrating a car A/V system with a cover opened according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

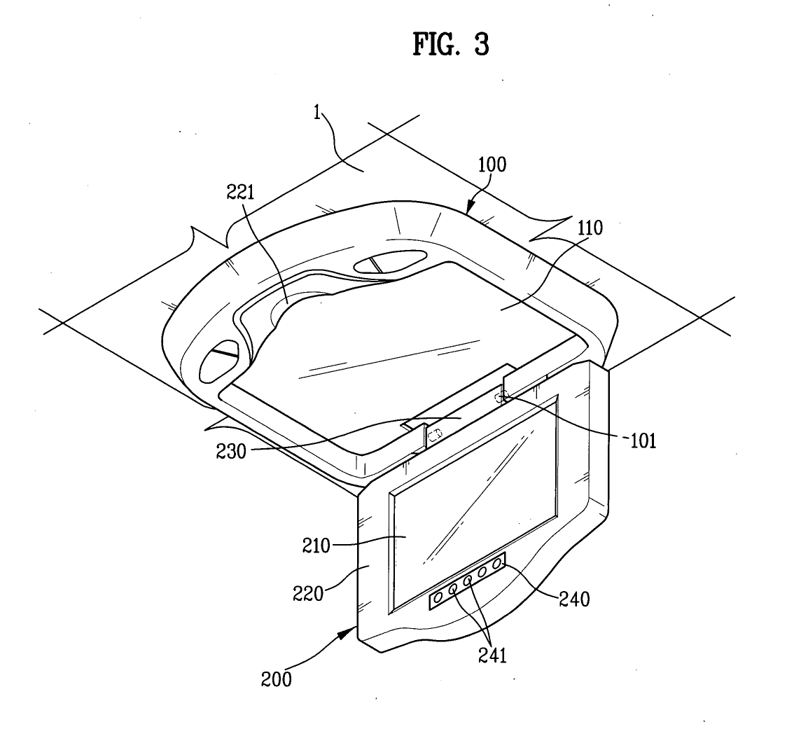

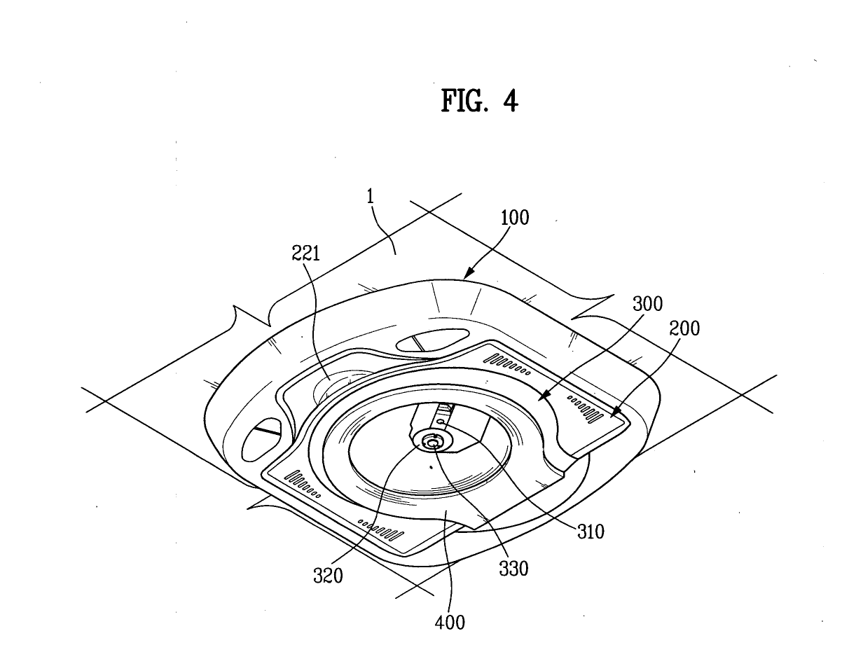

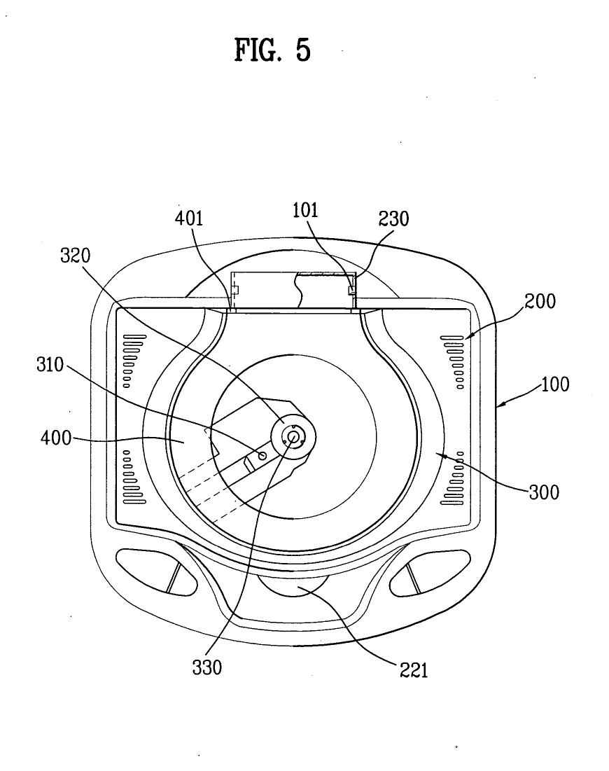

Hereinafter, with reference to FIG. 3 to FIG. 7, an embodiment of the car A/V system will be described in detail. First, the car A/V system of the present invention includes a housing part 100, a display part 200, and a disk player part 300 provided on a rear surface of the display part 200 as illustrated in FIG. 3 and FIG. 4.

The housing part 100 forming an outer appearance of the AV system is provided on a ceiling 1 inside of a car as illustrated in the embodiment.

In this case, the housing part 100 has an advantage of minimizing a total size of on a AV system because the disk player part 300 such as the DVD player is not provided therein.

Particularly, only circuit parts (not illustrated) for various controls are provided in the housing part 100. In this case, the various circuit parts do not largely influence a thickness of the housing part 100 and enable a disperse installation thereby the total size of the AV system is minimized.

In other words, the total thickness is minimized to a portion whereon the display part 200 is lied owing to an advantage of the disperse installation of the circuit parts in around the housing part 100.

By an influence of the circuit board, a part of circuit parts is, of course, provided in a center of the housing part 100. Therefore, it is desirable to design the circuit board (not illustrated) such that circuit parts with a low height are provided in the center of the housing part 100 and circuit parts with a high height are provided around an outer wall of the housing part 100.

It is desirable to further include a receiving part 110 on a lower surface of the housing part 100, particularly on the portion the display part 200 is overlaid, for minimizing the total thickness and a decline of a design effect resulted in the display exposed outside.

In this case, it is desirable that a depth of the receiving part 110 is about the same as the thickness of the display part 200. A side of the display part 200 is assembled to a side of the housing part 100 so as to be selectively received into the receiving part 110 of the housing part 100.

The display part 200 includes an LCD panel 210 for displaying a picture, a case 220 formed to cover a frame and a rear surface the LCD panel 210, a coupler 230 coupled to a rear side of the housing part 100, and an operator 240 having a plurality of operating buttons 241 as illustrated in FIG. 3.

In this case, as illustrated in FIG. 3 to FIG. 5, a hinge axis 101 is provided on the rear side of the coupler 230 and the coupler 230 being coupled with the hinge axis 101 is formed as a rotatable. Particularly, when the coupler 230 is rotated at a predetermined degree around the hinge axis 101, it is desirable that the coupler 230 is fixed at the corresponding degree.

Although an embodiment of the structure is not illustrated, the structure is broadly applied to a conventional car A/V system. The operating button 241 is a selection button for performing an action to the LCD panel 210 or controlling a tuning thereof.

If the LCD panel 210 is formed of a touch screen, the operating button 241 is not provided. In this case, when the display part 200 stands perpendicular to the housing part 100, the operator 240 is provided on a center lower part of the case 220 or on a portion extended in a round from the center lower part of the case 220 for a predetermined range.

In addition to this, when the display part 200 is received in the receiving part 110, it is difficult to eject the display part 200 manually because the display part 200 is received in the receiving part 110 of the housing part 100 as mentioned above.

Accordingly, it is desirable that the display part 200 further includes a handle groove 221 on a front side of the rear surface thereof as illustrated in each drawing of the present invention. In this case, it is best desirable that the handle groove 221 is provided for a passenger to easily eject the display part 200.

Although it is not illustrated, the handle may be individually manufactured and assembled to the case 220. When the display part 200 is closed, i.e., received in the receiving part 110, the LCD panel 210 faces the receiving part 110 and the rear surface of the case 220 is provided in a bottom direction of the receiving part 110.

Although it is not illustrated, a general button system with an elasticity structure may be applied. In other words, the display part 200 bounded by an elasticity material such as a spring is released by pressing a button and then ejected from the housing part 100.

The disk player part 300 is coupled to the rear surface of the display part 200 (rear surface of the case), that is, an opposite side of the LCD panel 210 of the display part 200.

In this case, although it is desirable that the disk displer part 300 and the display part 200 are formed as a single body, they may be individually manufactured and assembled or installed. The disk displer part 300 performs a role of playing various disks (for example, CD or DVD) and can be a DVD player.

Particularly, the disk player part 300 is not provided in the housing part 100 as the related art but a portion receiving the disk, i.e., a portion whereon a pick up device 310 and a turntable 320 are provided is exposed outside for enabling to identify whether the disk is received.

It is desirable that a clamp 330 is provided on the turntable 320 of the disk player part 300. In this case, the clamp 330 prevents the disk from leaving from a position of the disk during a rotation of the disk according to the rotation of the turntable 320.

However, although the clamp 330 is provided to the disk player part 300, there is a problem of the disk separated from the turntable 320 if the disk is rotated when the disk player part 300 is up side down on the rear surface of the display part 200 or when the disk player part 300 is perpendicularly provided.

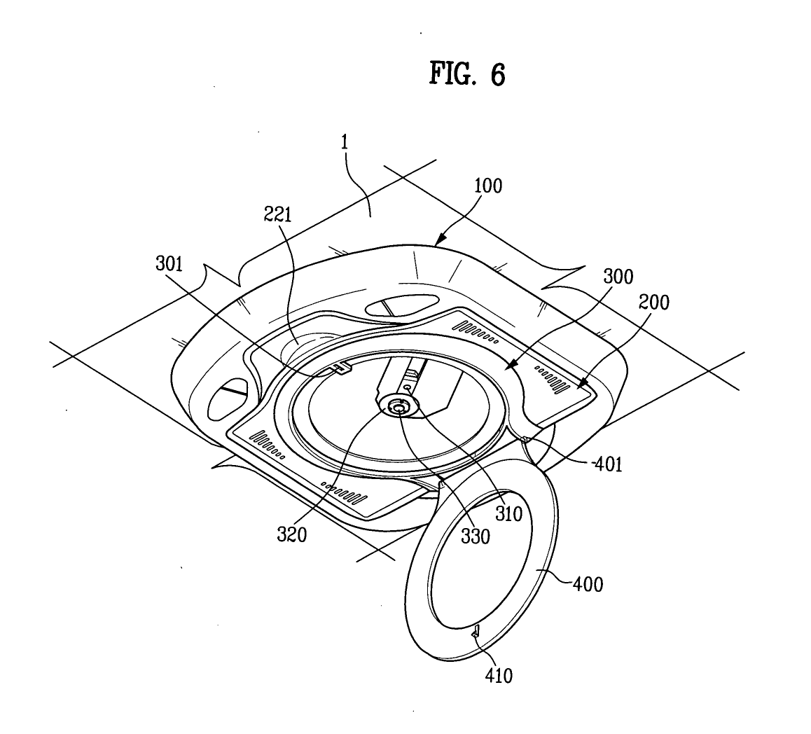

Accordingly, it is desirable that the disk player further includes a cover 400 thereon as illustrated in FIG. 6. In this case, it is desirable that the cover 400 is formed in a ring form with an opening inside.

Although it is not illustrated, an isolating film made of a transparent material may be further provided to the opening of the cover 400, or the whole cover 400 may be made of the transparent material.

Particularly, it is desirable that both ends of the cover are hinge-coupled with a rear side of the disk player part 300 as illustrated in FIG. 6 such that the cover 400 is rotated without relation to the rotation of the display part 200.

In other words, it is desirable that the disk is changed when the display part 200 is received in the receiving part 110, and when the display part 200 is ejected from the receiving part 110.

A hook 410 projected to a face of the disk player part 300 is provided on the cover 400 illustrated in FIG. 4 and an eye 310 corresponding to the hook is further provided on the face of the disk player part 300.

In this case, unless a separate power is supplied for opening, the hook 410 is restrained on the face of the disk player part 300 so as to maintain the cover 400 closed.

The disk player part 300 is electrically coupled with various circuit parts of the housing part 100 so as to receive and transmit various control signals through a gap provided at a junction between the display part 200 and the housing part 100.

Meanwhile, the A/V system of the present invention, as illustrated in aforementioned embodiment, is provided not only to the ceiling mount type A/V system provided on a car ceiling, but also to an adhesive A/V system such as a stand-alone type and a headrest type AV systems.

As described above, the A/V system of the present invention has an effect of minimizing a thickness of the whole product by minimizing the thickness of an overlaid portion.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A car AV system, comprising:
a housing part coupled to a predetermined location in a car;
a display part rotatably provided at a side of the housing part; and
a disk player part provided on a rear surface of the display part for playing various disks.

2. The car A/V system of claim 1, wherein the housing part is provided on a ceiling in the car.

3. The car A/V system of claim 1, wherein the housing part is provided in front of a driver seat in the car.

4. The car A/V system of claim 1, wherein the housing part is provided at a headrest in the car.

5. The car A/V system of claim 1, wherein the display part comprises:
an LCD panel for displaying a picture;
a case provided for covering a frame and a rear surface of the LCD;
a coupler coupled to the housing part; and
an operator having various control buttons.

6. The car A/V system of claim 1, wherein a receiving part is provided on a lower surface of the housing part for receiving the display part.

7. The car A/V system of claim 6, wherein a depth of the receiving part is almost the same as a thickness of the display part.

8. The car A/V system of claim 1, wherein the disk player part further comprises a cover rotatably provided for preventing the disk from being separated.

9. The car A/V system of claim 8, wherein the cover is formed in a ring form with an opening inside.

10. The car A/V system of claim 9, further comprising an isolating film provided to the opened portion of the cover.

11. The car A/V system of claim 8, wherein the cover is made of a transparent material.

12. The car A/V system of claim 8, further comprising:
a hook projected to a face of the disk player part on the cover; and
an eye corresponding to the hook on the face of the disk player part.

13. The car A/V system of claim 1, wherein the housing part comprises various circuit parts.

14. The car A/V system of claim 1, wherein the circuit parts are coupled with the disk player part through a junction between/of the display part and the housing part for receiving and transmitting various control signals.

15. The car A/V system of claim 1, further comprising a handle groove on the rear surface of the display part for gripping the disk player part.

16. The car A/V system of claim 15, wherein the handle groove is provided on a front end of the disk player part on the rear surface of the display part.

17. The car A/V system of claim 1, further comprising an individual handle on the rear surface of the display part for gripping the disk player part.

18. The car A/V system of claim 1, wherein the display part and the disk player part are individually manufactured and formed as a single body.

19. The car A/V system of claim 1, wherein the display part and the disk player part are individually manufactured and assembled.
